(19) United States
(12) Patent Application Publication
(10) Pub. No.: US 2019/0259596 A1
(43) Pub. Date: Aug. 22, 2019

(54) METHOD AND APPARATUS FOR DETERMINING THE PRESENCE OF IONS IN A SAMPLE BY RESONANCE IONIZATION

(71) Applicant: THE UNIVERSITY OF MANCHESTER, Manchester, Greater Manchester (GB)

(72) Inventors: Kieran FLANAGAN, Glossop (GB); Andrada FLUERAS, Cluj (RO); Cory BINNERSLEY, Manchester, Greater Manchester (GB)

(21) Appl. No.: 16/342,846

(22) PCT Filed: Oct. 16, 2017
(86) PCT No.: PCT/GB2017/053126

§ 371 Date: Apr. 17, 2019

(30) Foreign Application Priority Data
Oct. 18, 2016 (GB) 1617624.0

(51) Int. Cl. H01J 49/16; H01J 49/40

(52) U.S. Cl. CPC H01J 49/161; H01J 49/40

(57) ABSTRACT

A method of determining the presence ions in a sample, comprising: (i) resonantly ionising a sample beam containing the sample with one or more lasers arranged collinearly with the sample beam; (ii) obtaining data relating to resonantly produced electrons resulting from the ionisation of the sample beam; and (iii) determining the presence of ions in the sample using the data relating to resonant electrons.

This invention relates to a method and apparatus for determining the presence of ions in a sample, and, in particular, wherein the sample forms part of a sample beam.

### BACKGROUND

Apparatuses and methodologies for measuring trace isotopes in large samples are known and rely on the detection of ions. Most current techniques are typically limited to detecting isotopes at 1 part in 10¹³ or 10¹⁴. For example, Inductively Coupled Plasma Mass Spectrometry (ICP-MS) can reach a level of 1 part in 10¹⁴ but only where there are no interference species present, which is rarely the case. For ICP-MS the current limit is ranges from 1 ppb to 0.001 ppb (or 10⁻¹²) but in special cases this can be extended to below ppt (10⁻¹²).

Other prior art techniques for measuring trace isotopes permit detection at 1 part in 10¹⁵ or even 1 part in 10¹⁸ or 10¹⁹ with additional processing. Such techniques include the use of large accelerator mass spectrometers, such as the VERA facility in Wien which has a 3 MV Pelletron accelerator. However, such apparatuses are extremely costly (e.g. around £10 million), and the methodologies require a large team of personnel and take an undesirably long time period.

It is an object of certain embodiments of the present invention to overcome or mitigate certain disadvantages associated with prior art arrangements and methods.

### BRIEF SUMMARY OF THE DISCLOSURE

In accordance with an aspect of the present invention there is provided a method of determining the presence of ions in a sample, comprising:
resonantly ionising a sample beam containing the sample with one or more lasers arranged collinearly with the sample beam;
obtaining data relating to resonantly produced electrons resulting from the ionisation of the sample beam; and
determining the presence of ions in the sample using the data relating to resonant electrons.

The step of determining the presence of ions in the sample may comprise:
producing an ion signal relating to ions resulting from the resonant ionisation of the sample beam; and
processing the ion signal using the data relating to the resonantly produced electrons.

The method may further comprise the step of determining a resonance time period using the data relating to the resonantly produced electrons. In such embodiments, the step of processing the ion signal may comprise excluding parts of the ion signal that are not associated with the determined resonance time period.

In alternative embodiments, the method may further comprise determining a detection period using the data relating to the resonantly produced electrons, wherein determining the presence of ions in the sample may comprise detecting ions resulting from the resonant ionisation of the sample beam during the determined detection period. In such embodiments, the detection period may begin when a resonantly produced electron is detected. Alternatively, the detection period may begin after a delay period following the detection of a resonantly produced electron. In certain embodiments, the delay period may be a function of data relating to the time of flight of resonantly produced electrons and data relating to the time of flight of the sample beam. In particular, the delay period may be defined as T̅O̅F̅ₛₐₘₚₗₑ−T̅O̅F̅_{electron}, where T̅O̅F̅ₛₐₘₚₗₑ is the mean time of flight of sample beam and T̅O̅F̅_{electron} is the mean time of flight of the resonantly produced electrons.

In certain embodiments, the step of obtaining data relating to the resonantly produced electrons comprises detecting resonantly produced electrons. The method may comprise extracting resonantly produced electrons using a penetrating field extractor prior to the step of detecting resonantly produced electrons.

The step of detecting resonantly produced electrons may include rejecting collisional electrons. In certain embodiments, the step of rejecting collisional electrons may comprise deflecting collisional electrons away from resonantly produced electrons. A cylindrical deflector analyser may be used to deflect collisional electrons away from resonantly produced electrons.

In certain embodiments, the laser may be one or more pulsed and/or continuous wave lasers. Such suitable lasers include narrowband and broadband lasers. Suitable pulsed lasers may operate in the nanosecond range, and/or may include, without limitation, dye lasers TiSA lasers (which may be injection seeded), and Nd:YAG. Suitable Nd:YAG lasers may be pumped by flashlamps, fiber lasers or DPSS lasers. Suitable dye lasers and TiSa lasers may have a bandwidth greater than 1 GHz. Suitable injection seeded TiSA lasers may have a bandwidth between 6 and 100 MHz. Suitable continuous wave laser include, without limitation, ring dye lasers, TiSA lasers, diode lasers and fiber lasers and/or may have a bandwidth less than 5 MHz.

In certain preferable embodiments, the step of determining the presence of ions in the sample using the data relating to resonant electrons comprises identifying isotopes present in the sample.

In accordance with another aspect of the present invention, there is provided an apparatus for detecting ions in a sample, comprising:
a beam line for permitting the passage therethrough of a sample beam containing the sample;
one or more lasers arranged to provide one or more laser beams that are collinear with the beam line and configured to resonantly ionise a sample beam passing therethrough;
electron detection means in the form of an electron detector for detecting resonantly produced electrons resulting from the resonant ionisation of the sample beam; and
ion detection means in the form of an ion detector for detecting ions resulting from the resonant ionisation of the sample beam.

In certain embodiments, the apparatus may further comprise processing means in the form of a processor that is arranged to receive data from the electron detection means and receive data from the ion detection means, and configured to process the data received from the ion detection means using the data received from the electron detection means.

The laser may be one or more pulsed and/or continuous wave lasers. Such suitable lasers include narrowband and broadband lasers. Suitable pulsed lasers may operate in the nanosecond range, and/or may include, without limitation, dye lasers TiSA lasers (which may be injection seeded), and Nd:YAG. Suitable Nd:YAG lasers may be pumped by flashlamps, fiber lasers or DPSS lasers. Suitable dye lasers and TiSa lasers may have a bandwidth greater than 1 GHz. Suitable injection seeded TiSA lasers may have a bandwidth between 6 and 100 MHz. Suitable continuous wave laser include, without limitation, ring dye lasers, TiSA lasers, diode lasers and fiber lasers and/or may have a bandwidth less than 5 MHz.

### BRIEF DESCRIPTION OF THE DRAWINGS

Embodiments of the invention are further described hereinafter with reference to the accompanying drawings, in which:

FIG. 1 shows a method according to an embodiment of the present invention;

FIG. 2 shows steps of a method according to a specific embodiment of the present invention; and

FIG. 3 schematically shows an apparatus according to an embodiment of the present invention.

### DETAILED DESCRIPTION

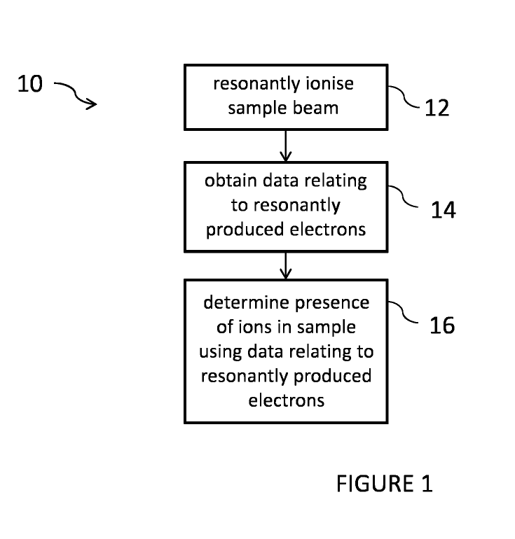

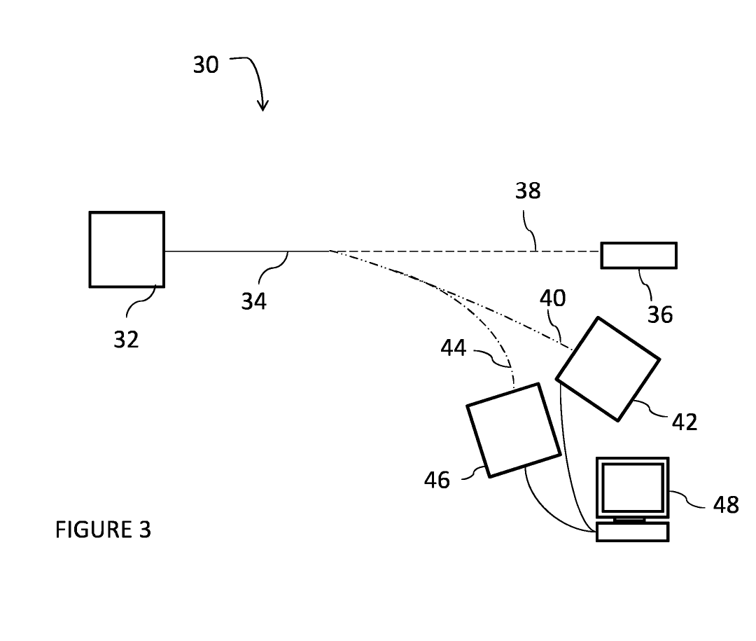

FIG. 1 illustrates a method 10 according to an embodiment of the present invention. In particular, the method 10 is for determining the presence of ions in a sample. FIG. 3 shows an apparatus 30 according to an embodiment of the present invention, where the apparatus 30 may be used to perform the methods according to embodiments of the invention.

The method 10 comprises the step 12 of resonantly ionising a sample beam containing the sample with a laser beam arranged collinearly with the sample beam. As shown in FIG. 3, a sample source 32 may provide a sample beam 34, and a laser 36 may be arranged to produce a laser beam 38 that is collinearly arranged with the sample beam 34. Throughout the present specification, the term “collinearly arranged” means coaxial, i.e. parallel and axially aligned. That is, the laser beam 36 is parallel to and axially aligned with at least a portion of the sample beam 34. The laser beam 38 is used to resonantly ionize the sample beam 34 in accordance with step 12 of the method 10.

In certain embodiments, the sample source 32 may be an atom, molecule or ion source. In embodiments in which the sample source 32 is an atom or molecule source, an energetic beam may be provided (i.e. accelerated) which may then be neutralized into an atom or neutral molecule. Examples of suitable ion sources include, but are not limited to, a plasma ion source, a sputter ion source, and a laser ion source. In certain embodiments, the sample source 32 may be held at a high voltage e.g. between 1 kV and 50 kV (however accelerating voltages outside of this range may be used to accelerate the sample beam 34).

Prior to the step 12 of resonantly ionizing the sample beam 34, the sample beam 34 may be mass separated (e.g. using a dipole magnet, velocity filter, or quadrupole mass filter). The mass separated sample beam 34 may then be injected into a gas-filled linear Paul trap, where the energy spread and beam emittance are reduced and ions are trapped. In other embodiments, other ion traps may be employed. In preferable embodiments, a spatial bunch length of the mass separated sample beam 34 is substantially the same or similar to a length of an interaction region in which resonant ionization takes place. The length of the interaction region will be determined by the parameters of the ion bunch. For example, at 30 keV and at mass 41 a bunch width from an ion trap of 1 μs represents/requires a 38 cm long interaction region. In certain embodiments, an interaction region of 1.5 m may be employed for ion bunches of several microseconds.

The bunched, mass separated sample beam 34 may then be transported to a neutralization unit using electrostatic optics. If there are no transitions accessible to laser radiation in the sample beam 34, the sample beam 34 may be neutralized, e.g. using an alkali metal vapour contained within a heated cell. An accelerating voltage may be applied to the hot cell to allow the velocity of the sample beam 34 to be changed for frequency scanning across an atomic transition. The bunched, mass separated sample beam 34 may then be transported through a differential pumping region into a region of high vacuum and low stray magnetic fields.

The resonant ionization of the sample beam 34 produces ions and additionally liberates electrons as part of the resonant ionization process. The ions produced may have single or multiple charge states (i.e. 1⁺ or >1⁺) depending on the ionization scheme employed. The resonant ionization process may comprise the stepwise excitation of the sample beam 34 using one or more resonant lasers. In certain embodiments, the laser 36 may be one or more pulsed and/or continuous wave lasers. Such suitable lasers include narrowband and broadband lasers. Suitable pulsed lasers may operate in the nanosecond range, and/or may include, without limitation, dye lasers TiSA lasers (which may be injection seeded), and Nd:YAG. Suitable Nd:YAG lasers may be pumped by flashlamps, fiber lasers or DPSS lasers. Suitable dye lasers and TiSa lasers may have a bandwidth greater than 1 GHz. Suitable injection seeded TiSA lasers may have a bandwidth between 6 and 100 MHz. Suitable continuous wave laser include, without limitation, ring dye lasers, TiSA lasers, diode lasers and fiber lasers and/or may have a bandwidth less than 5 MHz. The “resonantly produced electrons” (resulting from the resonant ionization of the sample beam 34) will have an energy in the rest frame of the atom/molecule/ion (from which it was liberated) that is dependent on the difference between a final ionizing energy of the laser 36 and the ionization potential of the atom/molecule/ion. In preferable embodiments, this difference is minimized as far as possible. As a result of the resonant ionization of the sample beam 34, electrons and ions are produced. The electrons may be extracted as an electron beam 40 for detection by an electron detector 42 and the ions may be extracted as an ion beam 44 for detection by an ion detector 46. However, the electrons will include resonantly produced electrons and electrons that arise due to collisions. Similarly, the ions will include resonantly produced ions and ions resulting from collisions. The process of non-resonant collisional ionization ordinarily results (i.e. in prior art arrangements) in large isobaric contamination that will contribute to the recorded background signal (i.e. noise) in an ion detection process.

The method 10 mitigates this problem by obtaining, at step 14, data relating to resonantly produced electrons resulting from the ionisation of the sample beam, and subsequently determining, at step 16, the presence of ions in the sample using the data relating to resonant electrons. With reference to the apparatus 30 illustrated in FIG. 3, the step 14 of obtaining data relating to resonantly produced electrons may comprise detecting the electron beam 40 using the electron detector 42. A guide magnetic field that is arranged parallel to the electron beam 40 may be used to aid the transport of resonantly produced electrons. As the resonantly produced ions and electrons leave the interaction region (where resonant ionization takes place), the electrons may be extracted using a penetrating field and, further, may be injected into an electrostatic lens before detection by the electron detector 42. In certain embodiments, the electron detector 42 may comprise an electron spectrometer such as a hemispherical electron spectrometer.

Since the electron beam 40 may include resonantly produced and non-resonantly produced electrons (e.g. collisional electrons), some filtering or processing may be performed so that an electron signal predominately relating to resonantly produced electrons may be obtained. For example, electrons detected outside of a particular time window may be rejected (or not detected in the first place), as such electrons may be determined to arise from processes other than resonance. Suitable selection of this time window will improve the integrity of the electron signal with regard to resonantly produced electrons. The selection of the time window will be dependent on the time of operation of the laser (i.e. when the ionization process took place). Additionally or alternatively, electrons having energies outside of a predetermined range (or ranges) may be rejected (or not detected in the first place). Again, such electrons may be considered to not result from resonance and may therefore be ignored in the interest of reducing the noise caused by non-resonant electrons in the electron signal. Similarly, at least some of the collisional electrons may be deflected away from the electron detector 42 (e.g. using a cylindrical deflector analyser) so as to not contribute to the electron signal.

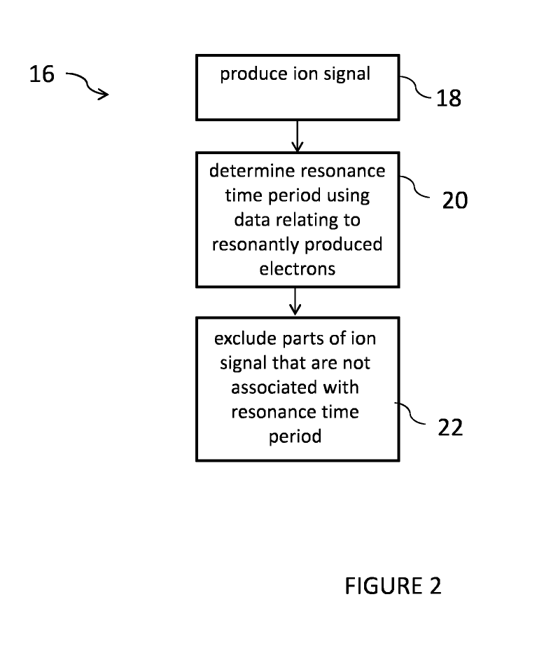

In a particular embodiment, the step 16 of determining the presence of ions in the sample using the data relating to resonant electrons comprises first producing 18 (see FIG. 2) an ion signal relating to ions resulting from the ionization of the sample beam 34. With reference to the apparatus 30 shown in FIG. 3, the step of producing the ion signal may comprise detecting the ion beam 44 with the ion detector 46. Secondly, the ion signal may be processed using the data relating to the resonantly produced electrons.

In particular embodiments, as illustrated in FIG. 2, the method 10 may further comprise the step 20 of determining a resonance time period using the data relating to the resonantly produced electrons, and the step of processing the ion signal may comprise excluding 22 parts of the ion signal that are not associated with the determined resonance time period. That is, the data relating to the resonantly produced electrons may be used to indicate when resonance was taking place and the time period associated with this resonance may be determined. The determined resonance time period may then be used (e.g. using coincidence logic) to process the ion signal, e.g. by truncating the ion signal to only include data that corresponds to the resonance time period. In this manner, the ion signal may be processed to reduce data contained therein that relates to non-resonantly produced ions. In doing so, the signal to noise ratio in respect of detection of resonant ions is greatly reduced. Indeed, an electron-ion coincidence signal can be used to reduce random background signals in both the electron detector 42 and the ion detector 46.

The apparatus 30 may further comprise processing means, e.g. as part of a computer or controller 48 as illustrated in FIG. 3, that are communicably coupled so as to receive data from the electron detector 42 and receive data from the ion detector 46. The processing means may be configured to process the data received from the ion detector 46 using the data received from the electron detector 42 to determine the presence of ions in the sample (e.g. by performing coincidence logic).

In certain preferable embodiments, the above-described method 10 may further determine the presence of isotopes using the determination of the presence of ions in the sample. In particular, the determination of a particular resonantly produced ion may permit an isotope contained within the sample to be identified.

In alternative embodiments, the method may further comprise determining a detection period using the data relating to the resonantly produced electrons. Determining the presence of ions in the sample may then comprise only detecting ions resulting from the ionisation of the sample beam during the determined detection period. For example, the detection period may begin when a resonantly produced electron is detected by the electron detector 42. Alternatively, the detection period may begin after a delay period following the detection of a resonantly produced electron. In certain embodiments, the delay period may be a function of data relating to the time of flight of resonantly produced electrons and data relating to the time of flight of the sample beam. In particular, the delay period may be defined as T̅O̅F̅ₛₐₘₚₗₑ−T̅O̅F̅_{electron}, where T̅O̅F̅ₛₐₘₚₗₑ is the mean time of flight of sample beam and T̅O̅F̅_{electron} is the mean time of flight of the resonantly produced electrons.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of determining the presence of ions in a sample, comprising:
resonantly ionizing a sample beam containing the sample with one or more lasers arranged collinearly with the sample beam;
obtaining data relating to resonantly produced electrons resulting from the resonant ionization of the sample beam; and
determining the presence of ions in the sample using the data relating to resonant electrons,
wherein obtaining data relating to the resonantly produced electrons comprises detecting resonantly produced electrons.

2. A method according to claim 1, wherein determining the presence of ions in the sample comprises:
producing an ion signal relating to ions resulting from the resonant ionization of the sample beam; and
processing the ion signal using the data relating to the resonantly produced electrons.

3. A method according to claim 2, further comprising determining a resonance time period using the data relating to the resonantly produced electrons, wherein processing the ion signal comprises excluding parts of the ion signal that are not associated with the determined resonance time period.

4. A method according to claim 1, further comprising determining a detection period using the data relating to the resonantly produced electrons, and wherein determining the presence of ions in the sample comprises detecting ions resulting from the resonant ionization of the sample beam during the determined detection period.

5. A method according to claim 4, wherein the detection period begins when a resonantly produced electron is detected.

6. A method according to claim 4, wherein the detection period begins after a delay period following the detection of a resonantly produced electron.

7. A method according to claim 6, wherein the delay period is a function of data relating to the time of flight of resonantly produced electrons and data relating to the time of flight of the sample beam.

8. A method according to claim 7, wherein the delay period is defined as T̅O̅F̅ₛₐₘₚₗₑ−T̅O̅F̅_{electron}, where T̅O̅F̅ₛₐₘₚₗₑ is the mean time of flight of sample beam and T̅O̅F̅_{electron} is the mean time of flight of the resonantly produced electrons.

9. (canceled)

10. A method according to claim 1, comprising extracting resonantly produced electrons using a penetrating field extractor prior to the step of detecting resonantly produced electrons.

11. A method according to claim 1, wherein detecting resonantly produced electrons includes rejecting collisional electrons.

12. A method according to claim 11, wherein rejecting collisional electrons comprises deflecting collisional electrons away from resonantly produced electrons.

13. A method according to claim 12, comprising using a cylindrical deflector analyzer to deflect collisional electrons away from resonantly produced electrons.

14. A method according to claim 1, wherein the one or more lasers includes one or more pulsed lasers and/or continuous wave lasers.

15. A method according to claim 1, wherein the step of determining the presence of ions in the sample using the data relating to resonant electrons comprises identifying isotopes present in the sample.

16. An apparatus for detecting ions in a sample, comprising:
a beam line for permitting the passage therethrough of a sample beam containing the sample;
one or more lasers arranged to provide one or more laser beams that are collinear with the beam line and configured to resonantly ionize a sample beam passing therethrough;
electron detection means for detecting resonantly produced electrons resulting from the resonant ionization of the sample beam;
ion detection means for detecting ions resulting from the resonant ionization of the sample beam; and
processing means arranged to receive data from the electron detection means and receive data from the ion detection means, and configured to process the data received from the ion detection means using the data received from the electron detection means.

17. (canceled)

18. An apparatus according to claim 16, wherein the one or more lasers includes one or more pulsed lasers and/or continuous wave lasers.

19. (canceled)
